(19) United States
(12) Patent Application Publication
(10) Pub. No.: US 2005/0177283 A1
(43) Pub. Date: Aug. 11, 2005

(54) Vehicular-light-beam-guidance apparatus used in moving vehicle

(76) Inventor: Shin-Po Lan, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 10/945,912

(22) Filed: Sep. 22, 2004

(30) Foreign Application Priority Data
Feb. 6, 2004 (TW) 093102990

(51) Int. Cl. G06F 17/00

(52) U.S. Cl. 701/1; 307/10.8

(57) ABSTRACT

A vehicular-light-beam-guidance apparatus used in moving vehicle mainly comprising a pair of light-beam apparatus for vehicular guidance, and being fixed nearby the both sides of the vehicle body. Then, a pair of parallel light-beams is spotlighted thereby and projecting over the road ahead and/or the protruding obstacle whereon with a width between each other thereof being approximately equal to that of the vehicle body. By means of said parallel light-beams, the driver can estimate the road width by naked eyes. As a basis, thus he can detect whether the vehicle body being able to pass therethrough in order to gain the driving safety efficiency under the environment of low visibility.

### FIELD OF THE INVENTION

The present invention relates to a vehicular-light-beam-guidance apparatus used in moving vehicle for gaining the safety efficiency of a moving vehicle, mainly comprising a pair of light-beam apparatus for vehicular guidance, and being fixed nearby the both sides of the vehicle body.

Then, a pair of parallel light-beams is spotlighted thereby and projecting over the road ahead with a width between each other thereof being approximately equal to that of the vehicle body.

By means of said parallel light-beams, the driver can estimate the road width by naked eyes. As a basis, thus he can immediately know whether the vehicle body being able to pass through the surface width of the road ahead in order to prevent the both sides of the vehicle body from bumping and to gain the driving safety.

### BACKGROUND OF THE INVENTION

Presently, the conventional vehicle, during moving or parking, it is avoided to bump against other vehicles or any protruding obstacles in the surrounding due to lacking precisely of detecting it in advance in consequence of driver's visual dead angle or insufficient visibility.

Thus, a distance-measuring pre-alarm apparatus is fixed at front or rear side of the vehicle body to aid detecting in order to signal the alarm beforehand to driver while the vehicle body is too close to any protruding obstacle in the surrounding.

The induction of said distance-measuring pre-alarm apparatus could be categorized into emitting electronic signal accompanying receiving with reflecting electronic signal type, or emitting light-beam accompanying receiving with reflecting light-beam type. (such as U.S. Pat. Nos. 5,357,432 ` 5,202,742 ` 6,181,410 and 3,469,234)

As shown of preceding patents said above, their serving as a pre-alarm apparatus are confined to detecting the distance between moving vehicle body and protruding obstacle in order to prevent it from bumping there-against in the surrounding.

Yet, concerning the moving vehicle without no guidance apparatus for detecting the width of the road is provided to ensure whether said moving vehicle body being able to pass through the space between two protrusions or the narrow lane with sunken ditches on both sides. Therefore, the drivers always estimate the width of road by naked eyes to pass therethrough without any guidance devices. As the result that some drivers are often happen to miss-estimate and cause the surface of vehicle body appear to bump-traces.

Besides, we can always see some moving vehicle bump against protrusions (such as utility pole, tree, vehicle or building) of both sides, or be bogged down due to lacking precisely of detecting it in advance to ensure whether being able to pass therethrough.

### SUMMARY OF THE PRESENT INVENTION

Accordingly, the prime goal of the present invention is aimed at moving vehicle, which driving through narrow lane ahead, or the space between two protrusions on the road surface, or narrow road with sunken ditches on both sides. By means of naked-eye-detecting the width of the road as a basis with the light-beam-guidance apparatus of the present invention, the driver is beforehand aware of whether the vehicle body being able to pass therethrough in order to prevent the both sides of the vehicle body from bumping and to gain the driving safety with convenience.

Namely, the invented vehicular light-beam-guidance apparatus used in moving vehicle comprising a pair of light-beam apparatus for vehicular guidance, and being fixed nearby the both sides of the vehicle body.

Then, a pair of parallel light-beams is spotlighted thereby and projecting over the road ahead with a width between each other thereof being approximately equal to that of the vehicle body.

By means of said parallel light-beams, the driver can estimate the road width by naked eyes. As a basis, thus he can immediately know whether the vehicle body being able to pass through the surface width of the road ahead in order to gain the driving safety and convenience under the environment of low visibility.

### BRIEF DESCRIPTION OF THE DRAWINGS

FIG. 1 is a lateral-sectional view of the preferred embodiment of the present invention.

FIG. 2 is a elevation-sectional view of the preferred embodiment of the present invention.

FIG. 3 is a structure perspective view of light-beam-guidance apparatus of the present invention.

FIG. 4 is a structure perspective view of light-beam-guidance apparatus being fixed in the headlight holder of the present invention.

### DETAILED DESCRIPTION OF THE PREFERRED EMBODIMENT

Following is the detailed description of the concrete embodiment case of the present invention assisted with accompanying figures to depict on features of various items and achievement effect in order to your further comprehension. Please refer to them together.

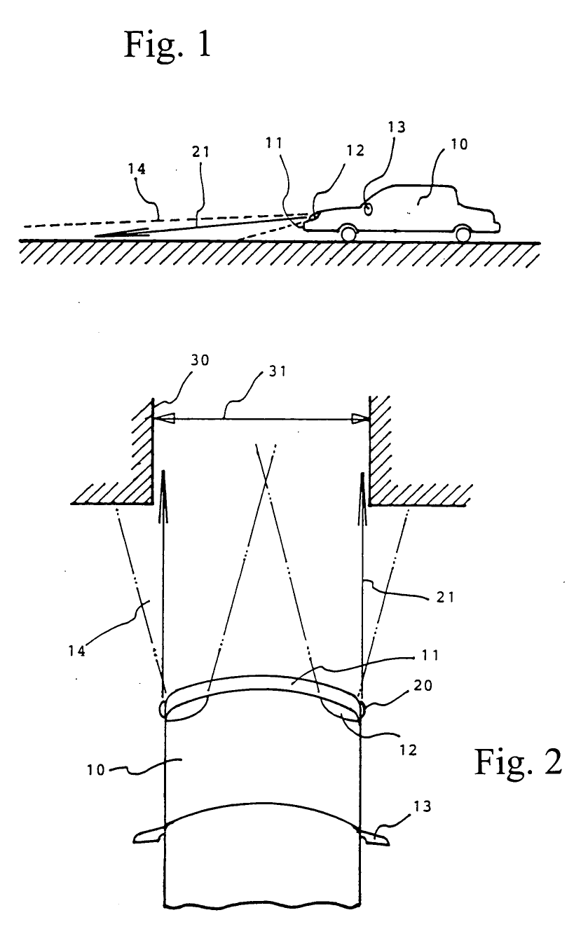

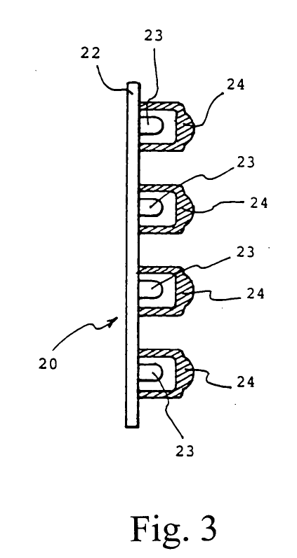

Referring to FIG. 1 to FIG. 3, the present invention is that a pair of light-beam guidance apparatus 20 being respectively fixed on the both ends of the front bumper 11 of the vehicle body 10. By means of function of said pair of light-beam guidance apparatus 20 having width between each other thereof equaling approximately that of vehicle body, the pair of parallel visible light-beam 21 can be projected over the surface of the road in front of vehicle. And said visible light-beam 21 are presented by different color with stronger illumination than that of the headlight beam 14.

Wherein said visible light-beam 21 is a kind of laser beam being constructed so that its illuminant 23 is fixed on a circuit 22 externally covered by a transparent condenser 24 thereon, and may have several ones in manner of vertical array (refer to FIG. 3).

By means of function in said visible light-beam 21, which produced by said pair of light-beam guidance apparatus 20, projecting over the surface of the road in front of vehicle, and having width between each other thereof equaling approximately that of vehicle body. The driver can directly detect by naked eye the surface width of the road 31 ahead, and as a basis to know whether the vehicle body 10 being able to pass it through.

Namely, refer to FIG. 2, as vehicle 10 intends to pass through a narrow road ahead, by means of said visible light-beam 21 projecting over the surface of the road ahead in proper distance manner.

If adequate space enough outside of said visible light-beam 21, said vehicle 10 can pass therethrough successfully by detecting of naked eye.

Contrarily, if insufficient space outside of said visible light-beam 21, or it already project against the protrusions (such as utility pole, tree, or building) or even sunken ditch, said vehicle 10 is unable to pass it through foreseeably.

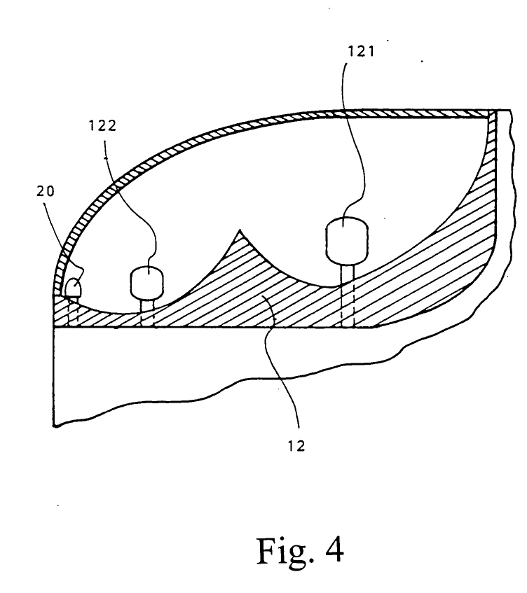

Continuously, refer to FIG. 4, said pair of light-beam-guidance apparatus 20 can also be respectively fixed outside position of the headlight holder 12 accommodating high-beam lamp 121 and low-beam lamp 122 to remain the expectable effect yet.

Or, said pair of light-beam-guidance apparatus 20 can also be respectively fixed on the directional lamp position, or outside position of the side-view mirror at both sides of the vehicle (refer to FIG. 1 and FIG. 2). It remains the same expectable effect yet.

Moreover, said visible light-beam 21 of said pair light-beam guidance apparatus 20 can be presented in dot or straight-line manner.

Summing up above descriptions, by means of a pair of light-beam apparatus being fixed nearby the both sides of the vehicle body. A pair of parallel light-beams is spotlighted thereby and projected over the road ahead with a width between each other thereof being approximately equal to that of the vehicle body. And, said visible light-beam is different color with stronger illumination than that of the headlight beam. So that the driver can foresee the road width by naked eyes as a basis to know whether the vehicle body being able to pass therethrough in order to prevent the both sides of the vehicle body from bumping and to gain the driving safety with convenience.

1. A vehicular-light-beam-guidance apparatus used in moving vehicle comprising:
a pair of light-beam apparatus being fixed nearby the both sides of the vehicle body, so that respective fixing positions with distance between each other thereof almost equal width of vehicle body, for projecting thereby a pair of visible parallel light-beam over the road ahead.

2. A vehicular-light-beam-guidance apparatus used in moving vehicle as recited in claim 1, wherein said visible light-beam is presented by different color with stronger illumination than that of headlight beam.

3. A vehicular-light-beam-guidance apparatus used in moving vehicle as recited in claim 1, wherein said visible light-beam is a kind of laser beam.

4. A vehicular-light-beam-guidance apparatus used in moving vehicle as recited in claim 1, wherein said light-beam-guidance apparatus is constructed so that its illuminant is fixed on a circuit, and is externally covered by a transparent condenser thereon.

5. A vehicular-light-beam-guidance apparatus used in moving vehicle as recited in claim 1, wherein said light-beam-guidance apparatus is constructed by several ones in manner of vertical array.

6. A vehicular-light-beam-guidance apparatus used in moving vehicle as recited in claim 1, wherein said pair of light-beam-guidance apparatus is respectively fixed outside position of the headlight holder accommodating high-beam lamp and low-beam lamp.

7. A vehicular-light-beam-guidance apparatus used in moving vehicle as recited in claim 1, wherein said pair of light-beam-guidance apparatus is respectively fixed on the directional lamp position at both sides of the vehicle body.

8. A vehicular-light-beam-guidance apparatus used in moving vehicle as recited in claim 1, wherein said pair of light-beam-guidance apparatus is respectively fixed outside position of the side-view mirror position at both sides of the vehicle.

9. A vehicular-light-beam-guidance apparatus used in moving vehicle as recited in claim 1, wherein said visible light-beam of the pair of light-beam-guidance apparatus is presented in dot manner.

10. A vehicular-light-beam-guidance apparatus used in moving vehicle as recited in claim 1, wherein said visible light-beam of the pair of light-beam-guidance apparatus is presented in straight-line manner.
